(19) United States
(12) Patent Application Publication
(10) Pub. No.: US 2006/0235842 A1
(43) Pub. Date: Oct. 19, 2006

(54) Web page ranking for page query across public and private

(75) Inventors: Benjamin H. Szekely, Boston, MA (US); Dan Smith, Stevens Point, WI (US); Robert Y. Wang, Suwanee, GA (US)

Correspondence Address: John E. Campbell;IBM Corporation, P386, 2455 South Road, Poughkeepsie, NY, 12601, US

(73) Assignee: International Business Machines Corporation, Armonk, NY (US)

(21) Appl. No.: 11/105,699

(22) Filed: Apr. 14, 2005

(51) Int. Cl. G06F 17/30

(52) U.S. Cl. 707/5

(57) ABSTRACT

Documents (web pages) are linked together preferably by Semantic Web links. A pages value is determined in part according to the number of links that link to it. The contribution of a link to the pages value is determined based on a user's accessibility of the page having the link. Accordingly page ‘A’ is linked to page ‘B’ wherein page ‘A’ is linked to by ‘x’ pages and page ‘B.’ is linked to by ‘y’ pages. The page value of page ‘A’ to page ‘B’ in determining page ‘B's rank is based in part on the number of qualified users having access to page ‘A’ as well as the number of links ‘x’ linking to page ‘A’.

### CROSS REFERENCE TO RELATED APPLICATIONS:

This application is related, and cross-reference may be made to the following co-pending U.S. patent application filed on even date herewith, assigned to the assignee hereof, and incorporated herein by reference:

U.S. Pat. Ser. No. ______ to Betz et al. for PAGE RANK FOR THE SEMANTIC WEB QUERY (Attorney Docket Number POU920040152US1).

### FIELD OF THE INVENTION

The present invention is related to computer search techniques. It is more particularly related to techniques for searching linked targets.

### BACKGROUND OF THE INVENTION

In order to find information in related databases a computerized search is performed. For example, on the World Wide Web, it is often useful to search for web pages of interest to a user. Various techniques are used including providing key words as the search argument. The key words are often related by Boolean expressions. Search arguments may be selectively applied to portions of documents such as title, body etc., or domain URL names for example. The searches my take into account date ranges as well. A typical search engine will present the results of the search with a representation of the page found including a title, a portion of text, an image or the address of the page. The results are typically arranged in a list form at the user's display with some sort of indication of relative relevance of the results. For instance, the most relevant result is at the top of the list following in decreasing relevance by the other results. Other techniques indicating relevance include a relevance number, a widget such as a number of stars or the like. The user is often presented with a link as part of the result such that the user can operate a GUI interface such as a curser selected display item in order to navigate to the page of the result item. Other well known techniques include performing a nested search wherein a first search is performed followed by a search within the records returned from the first search. Today many search engines exist expressly designed to search for web pages via the internet within the World Wide Web. Various techniques are utilized to improve the user experience by providing relevant search results.

Traditionally, graph analysis based rank engines such as GOOGLE's PAGERANK (GOOGLE and PAGERANK are trademarks of GOOGLE Inc.) have presumed only a single type of link, the hyper-link.

GOOGLE is a World Wide Web search engine found at www.GOOGLE.com. GOOGLE search engine ranks pages found in a search using GOOGLE's PAGERANK application. GOOGLE's PAGERANK is described on the World Wide Web at www.webworkshop.net/PAGERANK.html in an article “GOOGLE's PAGERANK Explained and how to make the most of it” by Phil Craven incorporated herein by reference.

GOOGLE's PAGERANK is a numeric value that represents how important a page is on the web. GOOGLE figures that when one page links to another page, it is effectively casting a vote for the other page. The more votes that are cast for a page, the more important the page must be. Also, the importance of the page that is casting the vote determines how important the vote itself is. GOOGLE calculates a page's importance from the votes cast for it. How important each vote is taken into account when a page's PAGERANK is calculated.

According to the referenced Craven article: To calculate the PAGERANK for a page, all of its inbound links are taken into account. These are links from within the site and links from outside the site.
PR(A)=(1−d)+d(PR(t1)/C(t1)+ . . . +PR(tn)/C(tn))

That's the equation that calculates a page's PAGERANK. It's the original one that was published when PAGERANK was being developed, and it is probable that GOOGLE uses a variation of it but they aren't telling us what it is. It doesn't matter though, as this equation is good enough.

In the equation ‘t1−tn’ are pages linking to page A, ‘C’ is the number of outbound links that a page has and ‘d’ is a damping factor, usually set to 0.85.

We can think of it in a simpler way:

a page's PAGERANK=0.15+0.85* (a “share” of the PAGERANK of every page that links to it)

“share”=the linking page's PAGERANK divided by the number of outbound links on the page.

A page “votes” an amount of PAGERANK onto each page that it links to. The amount of PAGERANK that it has to vote with is a little less than its own PAGERANK value (its own value * 0.85). This value is shared equally between all the pages that it links to.

From this, we could conclude that a link from a page with PR4 and 5 outbound links is worth more than a link from a page with PR8 and 100 outbound links. The PAGERANK of a page that links to yours is important but the number of links on that page is also important. The more links there are on a page, the less PAGERANK value your page will receive from it.

If the PAGERANK value differences between PR1, PR2 . . . PR10 were equal then that conclusion would hold up, but many people believe that the values between PR1 and PR10 (the maximum) are set on a logarithmic scale, and there is very good reason for believing it. Nobody outside GOOGLE knows for sure one way or the other, but the chances are high that the scale is logarithmic, or similar. If so, it means that it takes a lot more additional PAGERANK for a page to move up to the next PAGERANK level that it did to move up from the previous PAGERANK level. The result is that it reverses the previous conclusion, so that a link from a PR8 page that has lots of outbound links is worth more than a link from a PR4 page that has only a few outbound links.

Whichever scale GOOGLE uses, we can be sure of one thing. A link from another site increases our site's PAGERANK.

Note that when a page votes its PAGERANK value to other pages, its own PAGERANK is not reduced by the value that it is voting. The page doing the voting doesn't give away its PAGERANK and end up with nothing. It isn't a transfer of PAGERANK. It is simply a vote according to the page's PAGERANK value. It's like a shareholders meeting where each shareholder votes according to the number of shares held, but the shares themselves aren't given away. Even so, pages do lose some PAGERANK indirectly, as we'll see later.

For a page's calculation, its existing PAGERANK (if it has any) is abandoned completely and a fresh calculation is done where the page relies solely on the PAGERANK “voted” for it by its current inbound links, which may have changed since the last time the page's PAGERANK was calculated.

The equation shows clearly how a page's PAGERANK is arrived at. But what isn't immediately obvious is that it can't work if the calculation is done just once. Suppose we have 2 pages, A and B, which link to each other, and neither have any other links of any kind. This is what happens:

Step 1: Calculate page A's PAGERANK from the value of its inbound links

Page A now has a new PAGERANK value. The calculation used the value of the inbound link from page B. But page B has an inbound link (from page A) and its new PAGERANK value hasn't been worked out yet, so page A's new PAGERANK value is based on inaccurate data and can't be accurate.

Step 2: Calculate page B's PAGERANK from the value of its inbound links

Page B now has a new PAGERANK value, but it can't be accurate because the calculation used the new PAGERANK value of the inbound link from page A, which is inaccurate.

It's a Catch 22 situation. We can't work out A's PAGERANK until we know B's PAGERANK, and we can't work out B's PAGERANK until we know A's PAGERANK.

Now that both pages have newly calculated PAGERANK values, can't we just run the calculations again to arrive at accurate values? No. We can run the calculations, again using the new values and the results will be more accurate, but we will always be using inaccurate values for the calculations, so the results will always be inaccurate.

The problem is overcome by repeating the calculations many times. Each time produces slightly more accurate values. In fact, total accuracy can never be achieved because the calculations are always based on inaccurate values. 40 to 50 iterations are sufficient to reach a point where any further iterations wouldn't produce enough of a change to the values to matter. This is precisely what GOOGLE does at each update, and it's the reason why the updates take so long.

One thing to bear in mind is that the results we get from the calculations are proportions. The figures must then be set against a scale (known only to GOOGLE) to arrive at each page s actual PAGERANK. Even so, we can use the calculations to channel the PAGERANK within a site around its pages so that certain pages receive a higher proportion of it than others.

The GOOGLE algorithm is further discussed in “The Anatomy of a Large-Scale Hypertextual Web Search Engine” by Brin and Page on the World Wide Web at: “citeseer.ist.psu.edu/cache/papers/cs/13017/http:zSzzSzwww-db.stanford.eduzSzpubzSzpaperszSzGOOGLE.pdf/brin98anatomy.pdf” and incorporated herein by reference.

US Patent application Publication 20020129014A1 “Systems and methods of retrieving relevant information” filed Jan. 10, 2001 incorporated herein by reference provides systems and methods of retrieving the pages according to the quality of the individual pages. The rank of a page for a keyword is a combination of intrinsic and extrinsic ranks. Intrinsic rank is the measure of the relevancy of a page to a given keyword as claimed by the author of the page while extrinsic rank is a measure of the relevancy of a page on a given keyword as indicated by other pages. The former is obtained from the analysis of the keyword matching in various parts of the page while the latter is obtained from the context-sensitive connectivity analysis of the links connecting the entire Web. The patent also provides the methods to solve the self-consistent equation satisfied by the page weights iteratively in a very efficient way. The ranking mechanism for multi-word query is also described. Finally, the application provides a method to obtain the more relevant page weights by dividing the entire hypertext pages into distinct number of groups.

U.S. Pat. No. 6,701,305 “Methods, apparatus and computer program products for information retrieval and document classification utilizing a multidimensional subspace” filed Oct. 20, 2001 and incorporated herein by reference describes methods, apparatus and computer program products for retrieving information from a text data collection and for classifying a document into none, one or more of a plurality of predefined classes. In each aspect, a representation of at least a portion of the original matrix is projected into a lower dimensional subspace and those portions of the subspace representation that relate to the term(s) of the query are weighted following the projection into the lower dimensional subspace. In order to retrieve the documents that are most relevant with respect to a query, the documents are then scored with documents having better scores being of generally greater relevance. Alternatively, in order to classify a document, the relationship of the document to the classes of documents is scored with the document then being classified in those classes, if any, that have the best scores.

The prior art fails to take into account the contribution of user accessibility of documents when ranking documents.

The Semantic Web provides a common framework that-allows data to be shared and reused across application, enterprise, and community boundaries. It is a collaborative effort led by W3C with participation from a large number of researchers and industrial partners. It is based on the Resource Description Framework (RDF), which integrates a variety of applications using XML for syntax and URIs for naming. Information about RDF including “Resource Description Framework (RDF) Model and Syntax Specification found at “www.w3.org/TR/1999/REC-rdf-syntax-19990222”; “Resource Description Framework (RDF) Schema Specification at “www.w3.org/TR/1999/PR-rdf-schema-19990303”; and “RDF/XML Syntax Specification (Revised) at “www.w3.org/TR/rdf-syntax-grammar” all of which are incorporated herein by reference.

“The Semantic Web is an extension of the current web in which information is given well-defined meaning, better enabling computers and people to work in cooperation.” —Tim Berners-Lee, James Hendler, Ora Lassila, The Semantic Web, Scientific American, May 2001. More information about the semantic web can be found on the World Wide Web in the W3C Technology and Society Domain document “Semantic Web” at www.w3.or/2001/sw incorporated herein by reference.

As evidenced by the rapid success of GOOGLE's search technology, GOOGLE's PAGERANK is a powerful searching algorithm. However, this algorithm as it stands is assumes all pages in the search space are accessible by all search users. Pages that are not available to a user should not rank as valuable as those that are. A search technique is needed that takes page accessibility into account when ranking pages.

### SUMMARY OF THE INVENTION

In an embodiment, the invention provides page ranking values representing the importance of a web page based on the accessibility of the pages linking to the page, the accessibility determined in part by a list of users.

It is further an object of the invention to provide ranking of public and private documents by determining a first value, the first value representing a number of users having access to a first document of a first plurality of documents; determining a second value, the second value representing a number of users having access to a second document of a second plurality of documents, the first document having a first link to the second document; calculating a first rank of the second document, the calculation comprising a representation of the number of links of documents linking to the second document, the calculation penalizing the contribution of the first link when the first value is less than the second value; and associating the first rank with the second document.

It is further an object of the invention to determining a third value, the third value representing a number of users having access to the first document and the second document of the plurality of documents wherein the calculating the first rank of step c further comprises the step of: dividing the third value by the second value.

It is another object of the invention to perform a query on the plurality of documents; calculating relevance of the documents resulting from the search, wherein the calculation comprises the calculated rank of the documents; and presenting representations of the documents resulting from the search according to their calculated relevance.

It is another object of the invention to rank documents wherein ranking is restricted to documents of one or more predetermined domains.

It is yet another object of the invention to perform the calculation of the first rank based on any one of a semantic web link to the second document or a document having a link to the second document.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a diagram depicting prior art components of a computer system;

FIG. 2 is a diagram depicting a prior art network of computer systems;

FIG. 3 is an example simple set of page ranks depicting two different types of links;

FIG. 4 depicts ranking pages according to two groups;

FIG. 5 depicts pages linked together serially;

FIG. 6 depicts determining page rank according to the present invention; and

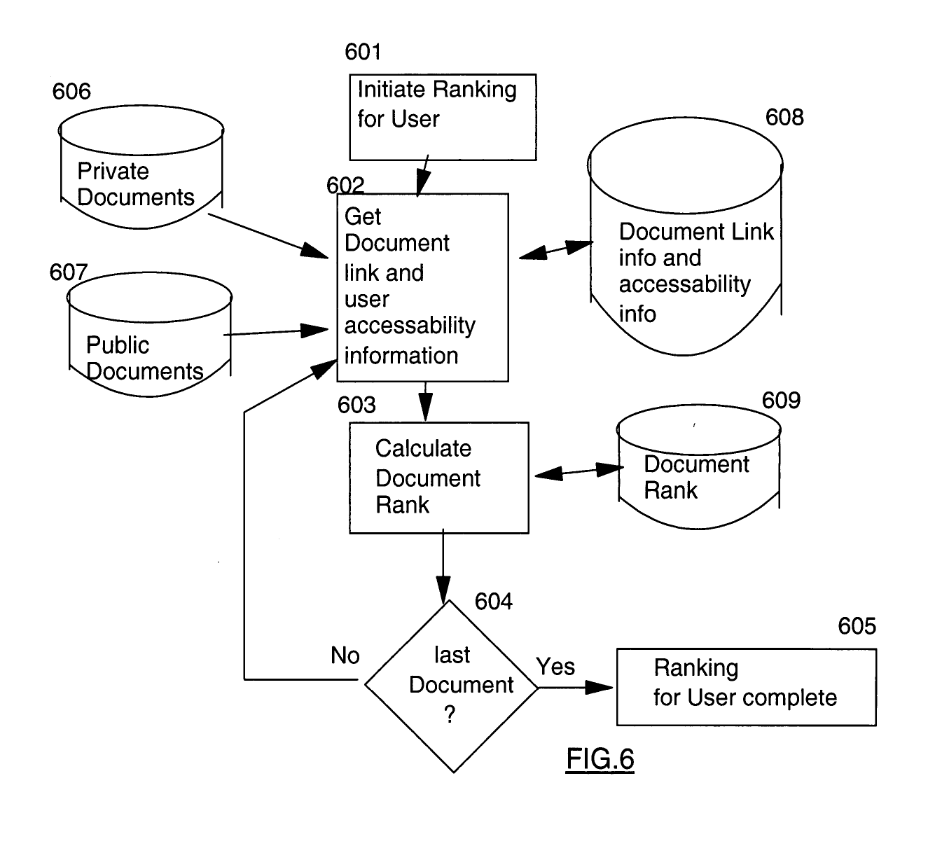

FIG. 7 depicts performing a query (search) of pages ranked according to the present invention.

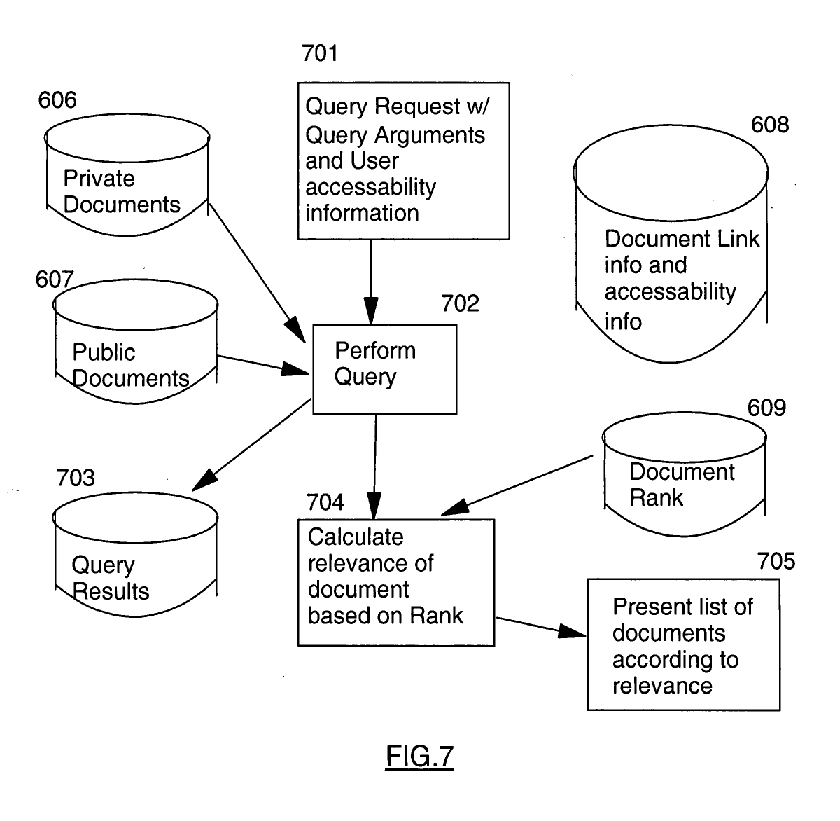

The detailed description explains the preferred embodiments of the invention, together with advantages and features, by way of example with reference to the drawings.

### DESCRIPTION OF THE PREFERRED EMBODIMENTS

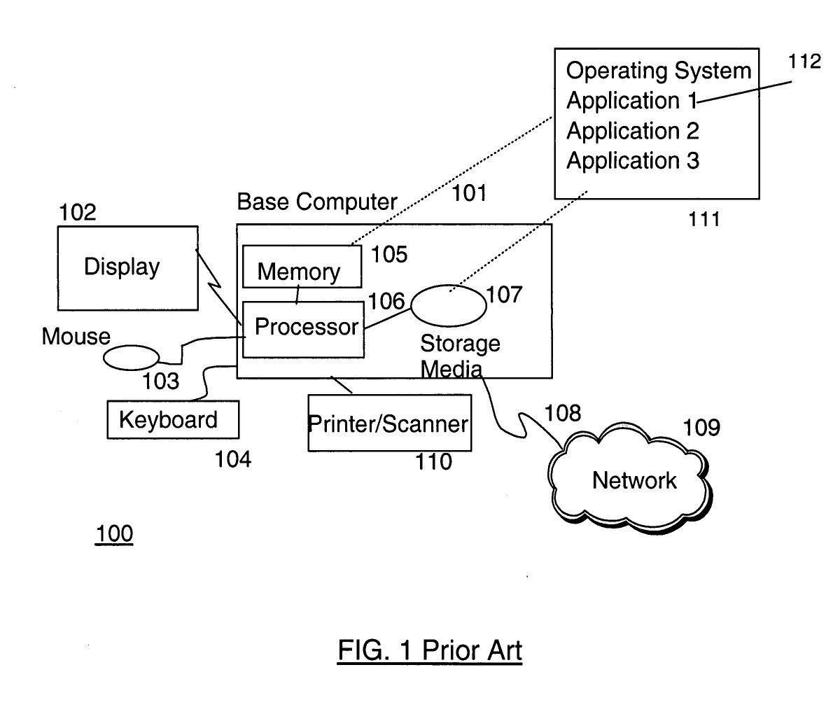

FIG. 1 illustrates a representative workstation or server hardware system in which the present invention may be practiced. The system 100 of FIG. 1 comprises a representative computer system 101, such as a personal computer, a workstation or a server, including optional peripheral devices. The workstation 101 includes one or more processors 106 and a bus employed to connect and enable communication between the processor(s) 106 and the other components of the system 101 in accordance with known techniques. The bus connects the processor 106 to memory 105 and long-term storage 107 which can include a hard drive, diskette drive or tape drive for example. The system 101 might also include a user interface adapter, which connects the microprocessor 106 via the bus to one or more interface devices, such as a keyboard 104, mouse 103, a Printer/scanner 110 and/or other interface devices, which can be any user interface device, such as a touch sensitive screen, digitized entry pad, etc. The bus also connects a display device 102, such as an LCD screen or monitor, to the microprocessor 106 via a display adapter.

The system 101 may communicate with other computers or networks of computers by way of a network adapter capable of communicating with a network 109. Example network adapters are communications channels, token ring, Ethernet or modems. Alternatively, the workstation 101 may communicate using a wireless interface, such as a CDPD (cellular digital packet data) card. The workstation 101 may be associated with such other computers in a Local Area Network (LAN) or a Wide Area Network (WAN), or the workstation 101 can be a client in a client/server arrangement with another computer, etc. All of these configurations, as well as the appropriate communications hardware and software, are known in the art.

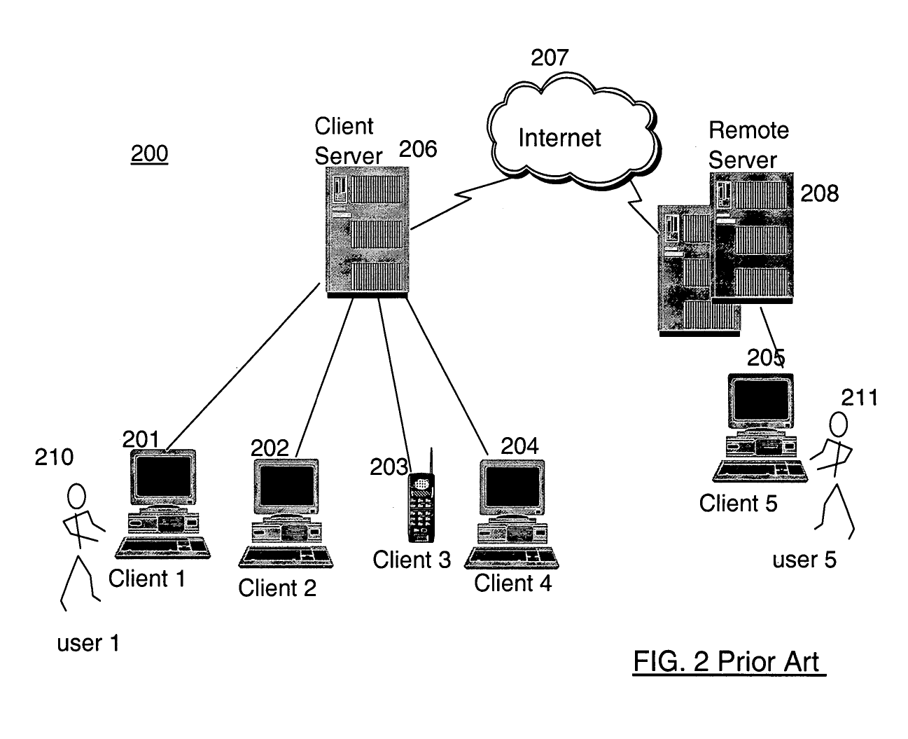

FIG. 2 illustrates a data processing network 200 in which the present invention may be practiced. The data processing network 200 may include a plurality of individual networks, such as a wireless network and a wired network, each of which may include a plurality of individual workstations 101. Additionally, as those skilled in the art will appreciate, one or more LANs may be included, where a LAN may comprise a plurality of intelligent workstations coupled to a host processor.

Still referring to FIG. 2, the networks may also include mainframe computers or servers, such as a gateway computer (client server 206) or application server (remote server 208 which may access a data repository). A gateway computer 206 serves as a point of entry into each network 207. A gateway is needed when connecting one networking protocol to another. The gateway 206 may be preferably coupled to another network (the Internet 207 for example) by means of a communications link. The gateway 206 may also be directly coupled to one or more workstations 101 using a communications link. The gateway computer may be implemented utilizing an IBM eServer zSeries® 900 Server available from IBM Corp.

Software programming code which embodies the present invention is typically accessed by the processor 106 of the system 101 from long-term storage media 107, such as a CD-ROM drive or hard drive. The software programming code may be embodied on any of a variety of known media for use with a data processing system, such as a diskette, hard drive, or CD-ROM. The code may be distributed on such media, or may be distributed to users from the memory or storage of one computer system over a network to other computer systems for use by users of such other systems.

Alternatively, the programming code 111 may be embodied in the memory 105, and accessed by the processor 106 using the processor bus. Such programming code includes an operating system which controls the function and interaction of the various computer components and one or more application programs. Program code is normally paged from dense storage media 107 to high speed memory 105 where it is available for processing by the processor 106. The techniques and methods for embodying software programming code in memory, on physical media, and/or distributing software code via networks are well known and will not be further discussed herein.

In the preferred embodiment, the present invention is implemented as one or more computer software programs 111. The implementation of the software of the present invention may operate on a user's workstation, as one or more modules or applications 111 (also referred to as code subroutines, or “objects” in object-oriented programming) which are invoked upon request. Alternatively, the software may operate on a server in a network, or in any device capable of executing the program code implementing the present invention. The logic implementing this invention may be integrated within the code of an application program, or it may be implemented as one or more separate utility modules which are invoked by that application, without deviating from the inventive concepts disclosed herein. The application 111 may be executing in a Web environment, where a Web server provides services in response to requests from a client connected through the Internet. In another embodiment, the application may be executing in a corporate intranet or extranet, or in any other network environment. Configurations for the environment include a client/server network, Peer-to-Peer networks (wherein clients interact directly by performing both client and server function) as well as a multi-tier environment. These environments and configurations are well known in the art.

Traditionally, graph analysis based rank engines such as GOOGLE's PAGERANK have presumed only a single type of link, the hyper-link, created by specifying an HTML anchor of the form <a href=“[URL]”>[ANCHOR TEXT]</A> in the document text. The present invention comprises an extension to this model utilizing the Semantic Web where there exist multiple types of links. The invention allows the user to refine a search by not only refining search terms, but also by specifying the types of links he may be interested in, through a “link interest vector.”

In a preferred embodiment, the algorithm proceeds as follows:

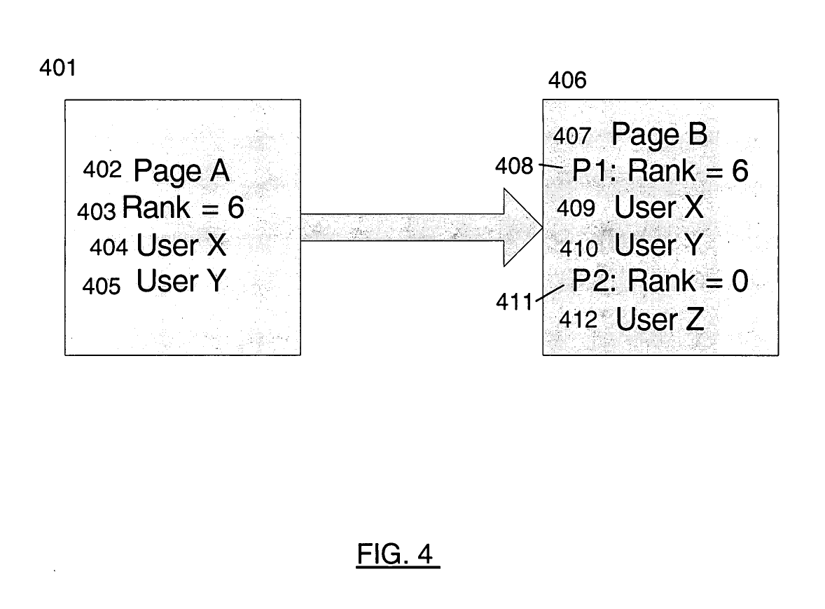

First, all the sub-graphs of the Semantic Web graph are built, where each sub-graph is the graph induced by one particular link or group of links. For example, the sub-graph induced by the link “citation” is the graph of papers that cite each other. These sub-graphs may contain several disconnected sections as not every page is reachable by every other page by even an arbitrarily large number of links. Next, the individual rank per document per sub-graph is computed, forming a “rank vector” (D) for each document. For example, referring to FIG. 4, suppose there exist three semantic links 402 404 407 that may be used to link pages together. Pages are linked to page “A” 401 via the three links 402 404 407. These three links induce three separate sub-graphs. In this example, D would be a length-3 vector containing the page rank for each of the sub-graphs computed using the traditional PAGERANK algorithm. The final rank per document is computed at query-time, when the user specifies a vector (I), assigning an interest weight for each type of link. Preferably, the document rank is simply the cosine similarity between the link interest vector and the document's rank vector: I.D/|I||D|. (Let V and W be arbitrary vectors: |V| denotes the length of V, and W.V is the dot-product of W and V.) Cosine similarity is discussed in “An Incremental Similarity Computation Method in Agglomerative Hierarchical Clustering” 2nd International Symposium on Advanced Intelligent Systems found at “brainew.com/research/publish/ISAIS2001/An_Incremental_Similarity_Computation_Method_in_Agglomerative_Hierarchical_Clustering.pdf” incorporated herein by reference.

Another form of calculating cosine similarity is:

$$σ ( D , Q ) = \frac{{\sum }_{k} ( {t}_{k} \times {q}_{k} )}{\sqrt{{\sum }_{k} {( {t}_{k} )}^{2}} \times \sqrt{{\sum }_{k} {( {q}_{k} )}^{2}}}$$

from “Practical 9: Implementing a similarity measure” University of Sunderland at: www.cet.sunderland.ac.uk/˜cs0cst/com268/sheets/practical_{—}9.doc

Other forms of calculating document rank are possible using techniques known in the art and would be suitable for implementing the present invention.

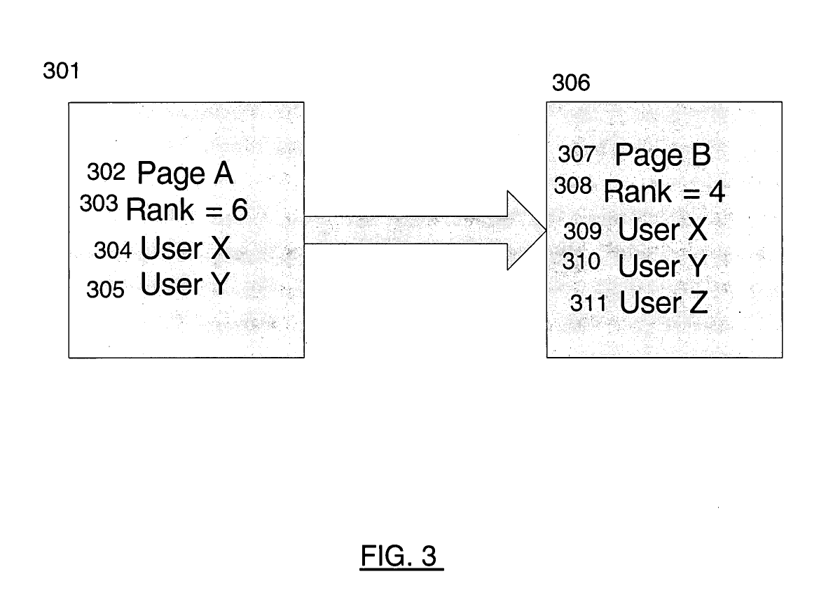

Referring again to FIG. 3, the relationship of semantic links to pages is depicted. The system is comprises of web pages 305 semantically linked to Page B 303 and to Page C 304. Page B has 5 pages semantically linked via a “Rank-pub” semantic link 306 307. Page C has 10 pages semantically linked via a “Rank_ref” semantic link 306 309. Page B 303 is semantically linked to page A 301 via a single “Rank-Pub” semantic link 302 and page C 304 is linked to page A 301 via a single “Rank_ref” semantic link 310. Page A therefore has Semantic Ranking of 5 for Rank_pub link and 10 for Rank_ref link derived form linked pages.

In a preferred embodiment, many semantic links will exist and it will be burdensome to compute a separate page rank for each link. Instead of specifying an interest vector whose entries are weights for individual links, the user specifies weights for groups of links. Examples of such groups of links are the set of links used by one particular organization and all links relating to the subject of publication. It is preferable to logically partition the links into interest categories. Two pages will be linked by a particular interest category if they are linked by at least one link in that category. Interest categories should be chosen so that computing one page rank per category is feasible. One such interest category might contain all semantic links relating to biology. Furthermore, one individual semantic link may belong to one or more interest categories. An interest category would preferably be implemented as a list, the list title comprising the category “biology” and the items on the list comprising the links included in the interest category.

In the context of the Semantic Web, a “page” is any document or data item which contains links to other documents or data. Specifically, pages are not restricted to HTML documents (HTML documents are often used to present a page in the World Wide Web). The links between Semantic Web pages are usually, but not always, defined in “RDF”. Furthermore, these links are semantic relationships in that they have a specific meaning or type. For example, “Author of” is a semantic link of such a relationship that may be used to link the page of an author to the page containing some publication that was authored by the author. The Semantic Web also supports additional metadata about pages. However, this metadata is beyond the scope of the present invention.

The present invention provides a method for utilizing the links between pages in the Semantic Web to provide better search capabilities. GOOGLE's PAGERANK algorithm uses links between pages as the basis for searching but it only considers one type of link. The Semantic Web allows arbitrary links between pages by labeling the link according to a Semantic “dictionary”.

To illustrate the improvement of the present invention over existing page-rank based searches, traditional page rank gives high relevance to search results that have high total “in-degree” on the World-Wide-Web, i.e. pages to which many other pages contain hyperlinks. The present invention yields search results that have many “in-bound” links wherein the links have a certain semantic meaning.

For example, a paper is published on the web by a usually popular author. Many publication indices may contain links (hyperlinks) to this paper. However, this paper turned out to contain inaccurate results, and hence, few other papers cite this paper. A search engine based on traditional PAGERANK, such as the GOOGLE search engine, might place this paper at the top of the search results for a search containing key-words in the paper because the paper web page is referenced by many web pages. This is a problem because even though the paper has high total in-degree, few other papers reference it, so this paper may rank low in the opinion of some knowledgeable users. The present invention solves this problem.

As evidenced by the rapid success of GOOGLE's search technology, GOOGLE's PAGERANK is a powerful searching algorithm. However, this algorithm as it stands is useful only when all pages in the search space are visible and accessible by all search users. The present invention provides a modification to the PAGERANK algorithm for search spaces whose pages are not all accessible by all users. Preferably, the search engine itself has access to all pages. Although this prohibits the use of this algorithm in such cases as a global internet search engine, it works well in a curated data hosting environment where the data items may be linked together. For example, a semantic web-based storage system where the data items are linked by semantic relationships but not all users have access to all data items

Although this modification to the Page Rank algorithm is applicable to Page Rank for the Semantic Web, it should be understood that the present invention can be applied to traditional page-rank as well.

The present invention proposes a solution to two anticipated problems in designing a search engine that spans public and private domains for example using a GOOGLE-like search engine.

1—Page ranks of public pages revealing the existence of private pages contributing to the page rank

2—Private pages boosting the page rank of public pages. Pages that a search user cannot access should not contribute to the page ranks of search results presented to that user.

The present invention provides a heuristic for ranking documents across public and private domains without unduly revealing private linkage to a random user. A private domain comprises a set of web pages that are not accessible to a user performing a web page query (search). The public domain is the domain of pages that are accessible to the user performing the web page query. The public domain comprises web pages links to and from private pages. In one embodiment, the web page links comprise Semantic Web links.

Under a preferred PAGERANK algorithm, a document's (web page) score (weight) is the sum of the values of its back links (links from other documents). A document having more back links is more valuable than one with less back links. As such, the existence of a private document may be inferred from its score impact on a public document through a link. In certain situations, a search user might not wish to have pages she does not have access to affecting her search results. GOOGLE's PAGERANK algorithm does not account for user accessibility to given pages when computing the rank.

For example, consider the computation of page A's rank. Consider page B who links to page A. Now suppose that 100 users have access to page A. Suppose also that only 2 of these users have access to B. An aspect of the present invention is to penalize page B's contribution to the page rank of page A because page B is not very accessible by A's users. The prior art PAGERANK algorithm didn't account for differences in page accessibility.

One approach to computing the above penalty would be to keep track of the access control lists for each of the back links of a document and only sum the links from accessible documents for the user issuing the query. Unfortunately, this approach only accounts for immediate neighbors of a search result. A particularly popular private document could still significantly affect the score of a public document if it were once removed from it by another public document. The optimal solution would be to compute the rank of the entire web graph for each user. This solution is burdensome for systems with large numbers of users since maintaining even a single page rank index is expensive as new pages are added to the system.

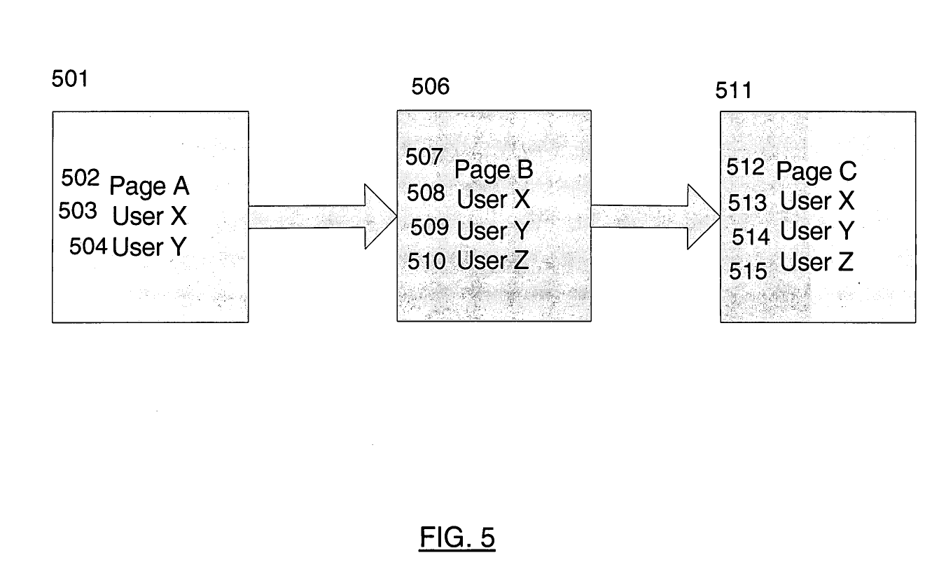

Consider the example in FIG. 5. Page A 502 is linked to Page B 507 which is linked to page C 512. User X and user Y have access to page A 503 504, B 508 509 and C 513 514. User Z has access to Page B 510 and C 515. If user Z performs a search that yields page C 512, the result will receive the full page rank contribution from page B 507 because the list of users are the same. However, inspecting one step back, user Z does not have access to page A 502, a contributor to page B's rank.

The present invention describes an approach that applies a heuristic to penalizing page rank having links between documents during a single rank computation as follows:

Let the page rank penalty “v” for a link “A” of page “A” to document “B” be defined as follows:
v=||A & B||/||B||
(where ||A & B|| denotes the number of users who may access both document “A” and document “B” and ||B|| denotes the number of users who may access document B. Furthermore, user accessibility may be due to any of a variety of well known techniques including but not limited to lists of user identities associated with domains or access control techniques beyond the scope of the present invention).

Apply the page rank penalty by multiplying it (v) against the A's rank contribution to B. (Note that in the case when both the document A and document B have the same users, ||A & B||=||B|| and by definition v=1, applying no penalty).

The page rank penalty is computed assuming the average user. For example, a super-user who could read all documents should probably not have a visibility penalty in any of her search results even though our algorithm may assign her one. Assuming the average user provides more accurate search results overall than having no penalty at all. Nevertheless, one solution to this problem is to assign each user a visibility score based on the percentage of pages they can view and scale search results using this score. A different heuristic would be to partition the users by group or department with the belief that users in a given partition have similar, if not exact permissions. A page rank penalty would then be computed for each partition of users for each page. v_p=||A_p & B_p||/||B_p|| where v_p, A_p, B_p are analogous to v, A, B above but considering only a partition of users, p. (A_p and B_p are pages accessible to user(s) “p”). In the case where users in a partition have identical permissions, each penalty v_p is ether 1 or 0 and we have exact results. A special case of such exact partitions is where each partition has a single user. (Assuming there are few enough users that computing all the partitions is practical).

An example of a visibility penalty.

FIG. 3 shows how Page A's 302 contribution to Page B's 307 page rank 308 is penalized because A 302 is not visible to all of B's 307 users. B's user list has 3 users 309 310 311 and A's has only 304 305. So we penalize the contribution of page A's Rank 303=6 by ⅔ to give B a page rank 308 of 4.

Referring to FIG. 4, an example of a visibility penalty with partitions.

In FIG. 4 users are partitioned into two partition, partition 1 (P1)=[X,Y] and partition 2 (P2)=[Z]. Since P1's users (x 404 409 and Y 405 410) have access to both pages, no penalty applied to the link for P1's users and the rank of B for P1 is 6. On the other hand, none of P2's users have access to Page A so the link for P2 is total penalized and B gets a rank of 0 for page P2. FIG. 2 illustrates this example.

An implementation of this modification to page ranks requires that the search engine know about the permissions of every page in the index. The present invention works well in a curated data hosting environment where the data items may be linked together. For example, a Semantic Web-based (see background) storage system where the data items are linked by semantic relationships but not all users have access to all data items. Such a system preferably includes a search engine based on the page rank of each data item. The page rank being computed using the links induced by the Semantic relationships.

As an example, consider a bioinformatics outsourcing company hosting a data repository for several pharmaceutical companies and several academic institutions. Each of these organizations has private data which resides in that organization's “Private Domain” (not accessible outside of authorized company organizations). In addition, each organization may have some amount of public data, such as papers or experimental methodologies that they wish to contribute to the “Public Domain”. The outsourcing company wishes to create a search engine that users in every organization may use to search that organization's Private Domain as well as the entire Public Domain.

Alice works on drug discovery at a private company, and Bob is a researcher at a university in chemical biology. Alice performs a search that initially matches two of Bob's papers. One paper, P is referenced (linked to) extensively by other public data and the other, Q is not. P would appear as a good search result to Bob while Q might not even appear at all. This is the desired behavior. Now consider researchers at the university performing searches. Many of Alice's drug research reports (private) might reference (linked from) Bob's public work at the university. However, since Alice's company keeps all of its research confidential (private), when other researchers at the university perform searches, Bob's pages will not be given higher weight due to Alice's pages that link to Bob's because Alice's pages are highly private compared to Bob's. That is, the visibility penalty for page rank imposed on the link from one of Alice's pages to one of Bob's will be high.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment of the invention has been illustrated and described herein, it is to be understood that the invention is not limited to the precise construction herein disclosed, and the right is “reserved” to all changes and modifications coming within the scope of the invention as defined in the appended claims.

What is claimed is:

1. A method for ranking electronic documents, the method comprising the steps of:
determining a first accessibility value of a first electronic document having a first rank value, the first electronic document comprising a first link to a second document;
determining a second rank value of the second electronic document, the second rank value based on the first accessibility value; and
storing the second rank value in a store.

2. The method according to claim 1, comprising the further steps of:
determining the first rank value based on one or more electronic documents linking to the first electronic document;
determining the second rank value of the second electronic document based on accessibility values of a plurality of electronic documents linking to the second electronic document; and
associating the stored second rank value with the second electronic document.

3. The method according to claim 1 wherein the method steps are repeated for a plurality of electronic documents.

4. The method according to claim 1 wherein the electronic documents consist of any one of a web page or-a semantic web page and wherein the first link consists of any one of a web page link or a semantic web page link.

5. The method according to claim 2 comprising the further step of:
determining a second accessibility value of a third electronic document having a third rank value, the third electronic document comprising a third link to the second document.

6. The method according to claim 1 wherein the first accessibility value is based on a number of one or more users having access to the first electronic document and a number of one or more users having access to the second electronic document.

7. The method according to claim 6 wherein users having access are users selected from the list consisting of users of a predetermined domain, and authorized users.

8. The method according to claim 1 wherein determining the first accessibility comprises the step of:
calculating a Cosine similarity value comprising the further steps of:
determining a first value, the first value representing a number of users having access to both the first electronic document and the second electronic document;
determining a second value, the second value representing a number of users having access to the second electronic document; and
determining the contribution of the first link by performing the step of dividing the first value by the second value.

9. The method according to claim 1 comprising the further steps of:
performing a query on the electronic documents;
calculating relevance of the electronic documents resulting from the search, wherein the calculation is based on saved rank values of the electronic documents; and
presenting representations of the electronic documents resulting from the search according to their calculated relevance.

10. The method according to claim 8 wherein the calculated relevance of a document presented is indicated by an indicator, the indicator consisting any one of display position, displayed widget, display color, listing priority or text highlighting.

11. A system for ranking public and private documents, the system comprising:
a network;
a first computer system in communication with the network wherein the computer system includes instructions to execute a method comprising the steps of:
determining a first accessibility value of a first electronic document having a first rank value, the first electronic document comprising a first link to a second document;
determining a second rank value of the second electronic document, the second rank value based on the first accessibility value; and
storing the second rank value in a store.

12. The system according to claim 11, comprising the further steps of:
determining the first rank value based on one or more electronic documents linking to the first electronic document;
determining the second rank value of the second electronic document based on accessibility values of a plurality of electronic documents linking to the second electronic document; and
associating the stored second rank value with the second electronic document.

13. The system according to claim 11 wherein the system steps are repeated for a plurality of electronic documents.

14. The system according to claim 11 wherein the electronic documents consist of any one of a web page or a semantic web page and wherein the first link consists of any one of a web page link or a semantic web page link.

15. The system according to claim 12 comprising the further step of:
determining a second accessibility value of a third electronic document having a third rank value, the third electronic document comprising a third link to the second document.

16. The system according to claim 11 wherein the first accessibility value is based on a number of one or more users having access to the first electronic document and a number of one or more users having access to the second electronic document.

17. The system according to claim 16 wherein users having access are users selected from the list consisting of users of a predetermined domain and authorized users.

18. The system according to claim 11 wherein determining the first accessibility comprises the step of:
calculating a Cosine similarity value comprising the further steps of:
determining a first value, the first value representing a number of users having access to both the first electronic document and the second electronic document;
determining a second value, the second value representing a number of users having access to the second electronic document; and
determining the contribution of the first link by performing the step of dividing the first value by the second value.

19. The system according to claim 11 comprising the further steps of:
performing a query on the electronic documents;
calculating relevance of the electronic documents resulting from the search, wherein the calculation is based on saved rank values of the electronic documents; and
presenting representations of the electronic documents resulting from the search according to their calculated relevance.

20. The system according to claim 19 wherein the calculated relevance of a document presented is indicated by an indicator, the indicator consisting any one of display position, displayed widget, display color, listing priority or text highlighting.

21. A computer program product for ranking public and private documents, the computer program product comprising:
a storage medium readable by a processing circuit and storing instructions for execution by a processing circuit for performing a method comprising:
determining a first accessibility value of a first electronic document having a first rank value, the first electronic document comprising a first link to a second document;
determining a second rank value of the second electronic document, the second rank value based on the first accessibility value; and
storing the second rank value in a store.

22. The computer program product according to claim 21, further comprising:
determining the first rank value based on one or more electronic documents linking to the first electronic document;
determining the second rank value of the second electronic document based on accessibility values of a plurality of electronic documents linking to the second electronic document; and
associating the stored second rank value with the second electronic document.

23. The computer program product according to claim 21 wherein the computer program product steps are repeated for a plurality of electronic documents.

24. The computer program product according to claim 21 wherein the electronic documents consist of any one of a web page or a semantic web page and wherein the first link consists of any one of a web page link or a semantic web page link.

25. The computer program product according to claim 22 comprising the further step of:
determining a second accessibility value of a third electronic document having a third rank value, the third electronic document comprising a third link to the second document.

26. The computer program product according to claim 21 wherein the first accessibility value is based on a number of one or more users having access to the first electronic document and a number of one or more users having access to the second electronic document.

27. The computer program product according to claim 26 wherein users having access are users selected from the list consisting of users of a predetermined domain and authorized users.

28. The computer program product according to claim 21 wherein determining the first accessibility comprises the step of:
calculating a Cosine similarity value comprising the further steps of:
determining a first value, the first value representing a number of users having access to both the first electronic document and the second electronic document;
determining a second value, the second value representing a number of users having access to the second electronic document; and
determining the contribution of the first link by performing the step of dividing the first value by the second value.

29. The computer program product according to claim 21 comprising the further steps of:
performing a query on the electronic documents;
calculating relevance of the electronic documents resulting from the search, wherein the calculation is based on saved rank values of the electronic documents; and
presenting representations of the electronic documents resulting from the search according to their calculated relevance.

30. The computer program product according to claim 28 wherein the calculated relevance of a document presented is indicated by an indicator, the indicator consisting of any one of display position, displayed widget, display color, listing priority or text highlighting.
